(19) United States
(12) Patent Application Publication
(10) Pub. No.: US 2025/0087154 A1
(43) Pub. Date: Mar. 13, 2025

(54) PIXEL CIRCUIT AND DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventors: Wei WANG, Wuhan, Hubei (CN); Qing HUANG, Wuhan, Hubei (CN)

(21) Appl. No.: 18/567,892

(22) PCT Filed: Jun. 30, 2023
(86) PCT No.: PCT/CN2023/104632

§ 371 Date: Dec. 7, 2023

(30) Foreign Application Priority Data
Nov. 7, 2022 (CN) 202211386682.5

(51) Int. Cl. G09G 3/3233

(52) U.S. Cl. CPC G09G 3/3233; G09G 2300/0819; G09G 2300/0852; G09G 2300/0861; G09G 2310/08; G09G 2320/0233

(57) ABSTRACT

The present disclosure discloses a pixel circuit and a display panel. The pixel circuit includes a first light-emitting control transistor, a first initialization transistor, a first transistor, a light-emitting device, and a first capacitor. In the case that a reset current and a luminescent current flowing through the first light-emitting control transistor remain unchanged, the light-emitting current flowing through the light-emitting device which is a part of the luminescent current flowing through the first light-emitting control transistor is kept constant.

### FIELD OF INVENTION

The present disclosure relates to the field of display technology, more particularly to a pixel circuit and a display panel.

### BACKGROUND

In pixel circuits, the characteristic stability of light-emitting devices is one of the key factors affecting the quality of the display. As the operating time of the pixel circuit or display panel increases, or the operating time in high temperature and humidity environments, the characteristics of the light-emitting device will change, which usually leads to a change in the brightness of the light-emitting device.

### TECHNICAL PROBLEM

The present disclosure provides a pixel circuit and a display panel to alleviate the technical problem that the brightness of the light-emitting device changes with its own characteristics.

### TECHNICAL SOLUTION

In a first aspect of the present disclosure, the present disclosure provides a pixel circuit. The pixel circuit comprises a first power line, a second power line, a driving transistor, a first light-emitting control transistor, a light-emitting device, a first node, a first initialization line, a first capacitor, and a first transistor. The driving transistor, the first light-emitting control transistor and the light-emitting device are connected in series between the first power line and the second power line. The first node is between the first light-emitting control transistor and the light-emitting device. The first initialization line is electrically connected to the first node through a first initialization transistor. The first capacitor is connected between the first node and a potential transmission line. The first transistor is connected between the first node and the light-emitting device.

In some embodiments of the present disclosure, a gate of the first light-emitting control transistor is connected with a light-emitting control line, a gate of the first initialization transistor is connected with a first control line, and a gate of the first transistor is connected with a second control line.

In some embodiments of the present disclosure, the potential transmission line is used to transmit a constant voltage signal.

In some embodiments of the present disclosure, the potential transmission line is one of the first power line, the first initialization line or the second power line.

In some embodiments of the present disclosure, a channel type of the first light-emitting control transistor is the same as a channel type of the first transistor, and the second control line is a luminescent control line.

In some embodiments of the present disclosure, the pixel circuit further comprises a second initialization transistor. One of a source or a drain of the second initialization transistor is connected with a gate of the driving transistor, the other of the source or the drain of the second initialization transistor is connected to the second initialization line, and a gate of the second initialization transistor is connected to the third control line. The potential transmission line is the first power line or the second initialization line.

In some embodiments of the present disclosure, the pixel circuit further includes a second light-emitting control transistor. One of the source or drain of the second light-emitting control transistor is connected to the other of the source or drain of the driving transistor, the other of the source or drain of the second light-emitting control transistor is connected to the first power line, and a gate of the second light-emitting control transistor is connected to the light-emitting control line or the second control line.

In some embodiments of the present disclosure, in a writing stage of the pixel circuit, the first initialization line receives the first initialization signal, the first light-emitting control transistor and the first transistor are cut-off, and the first initialization signal is transmitted to the first capacitor through the first initialization transistor.

In some embodiments of the present disclosure, in a light-emitting stage of the pixel circuit, the first light-emitting control transistor, the second light-emitting control transistor, the driving transistor, and the first transistor are turned on, and charge in a self-capacitance of the light-emitting device flows to the first capacitor through the first transistor.

In a second aspect of the present disclosure, a display panel includes a plurality of pixel circuits as provided in the above embodiments.

In some embodiments of the present disclosure, in the display panel, a conduction time period of the first light-emitting control transistor is the same as a conduction time period of the first transistor.

### ADVANTAGEOUS EFFECT

In the pixel circuit and display panel provided in the present disclosure, by coupling the first transistor and the first capacitor between the first light-emitting control transistor and the light-emitting device, the reset current flowing through the first initialization transistor is relevant to the first capacitor regardless of a capacitance of the light-emitting device. Because the change in the capacitance of the first capacitor with time is almost negligible, the reset current will not change with the change of capacitance of the light-emitting device to remain unchanged. The reset current is a part of the luminescent current flowing through the first light-emitting control transistor. Since the rest current and the luminescence current flowing through the first light-emitting control transistor remain unchanged, the luminescent current flowing through the light-emitting device as another part of the luminescent current flowing through the first light-emitting control transistor is kept constant, thereby reducing or avoiding the influence of the change of the capacitance of the light-emitting device on its luminous brightness.

### BRIEF DESCRIPTION OF THE DRAWINGS

FIG. 1 illustrates a circuit diagram of a conventional pixel circuit.

FIG. 2 illustrates a diagram of a color difference between the low grayscale white picture before and after high temperature and high humidity.

FIG. 3 illustrates the capacitance change of different colors of light-emitting devices after high temperature and high humidity.

FIG. 4 is a circuit diagram of a pixel circuit according to an embodiment of the present disclosure.

FIG. 5 illustrates a timing diagram of the pixel circuit shown in FIG. 1 and FIG. 4.

FIG. 6 illustrates a state of the pixel circuit shown in FIG. 4 during a T1 period of FIG. 5.

FIG. 7 illustrates a state of the pixel circuit shown in FIG. 4 during a T2 period in FIG. 5.

FIG. 8 illustrates a state of the pixel circuit shown in FIG. 4 during a T3 period of FIG. 5.

### DETAILED DESCRIPTION OF PREFERRED EMBODIMENTS

In order to make the purpose, technical solution and effect of the present disclosure clearer and clearer, the present disclosure is further detailed with reference to the accompanying drawings and examples of embodiments. It should be understood that the specific embodiments described herein are only used to interpret the present disclosure and are not intended to qualify the present disclosure.

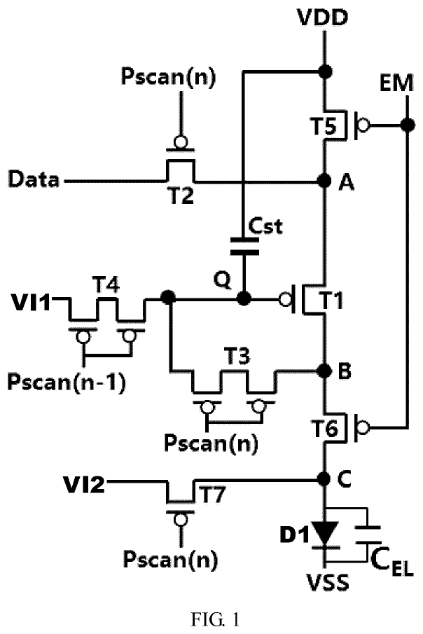

FIG. 1 illustrates a circuit diagram of a conventional pixel circuit. The pixel circuit includes a driving transistor T1, a first light-emitting control transistor T6, a second light-emitting control transistor T5, a first initialization transistor T7, a second initialization transistor T4, a write transistor T2, a compensation transistor T3, a light-emitting device D1, and a second capacitor Cst.

The first power line is connected with one terminal of the second capacitor Cst and one of a source or a drain of the second light-emitting control transistor T5. The other of the source or drain of the second light-emitting control transistor T5 is connected to one of the source or drain of the driving transistor T1. One of the source or drain of the driving transistor T1 is connected to the source or drain of the first light-emitting control transistor T6. One of the source or drain of the first light-emitting control transistor T6 is connected to the anode of the light-emitting device D1. A cathode of the light-emitting device D1 is connected to the second power line. A gate of the first light-emitting control transistor T6 is connected to a gate of the second light-emitting control transistor T5 and the light-emitting control line. The other terminal of the second capacitor Cst is connected to a gate of the driving transistor T1.

One of the source or drain of the first initialization transistor T7 is connected to the anode of the light-emitting device D1. The other of the source or drain of the first initialization transistor T7 is connected to the first initialization line. A gate of the first initialization transistor T7 is connected to the first control line.

One of the source or drain of the second initialization transistor T4 is connected to the gate of the driving transistor T1. The other of the source or drain of the second initialization transistor T4 is connected to the second initialization line. A gate of the second initialization transistor T4 is connected to the third control line.

One of the source or drain of the write transistor T2 is connected to one of the source or drain driving transistor T1. The other of the source or drain of write transistor T2 is connected to the data line. A gate of the write transistor T2 is connected to the first control line.

One of the source or drain of the compensation transistor T3 is connected to the other of the source or drain of the driving transistor T1. The other of the source or drain of the compensation transistor T3 is connected to the gate of the driving transistor T1. A gate of the compensation transistor T3 is connected to the first control line.

It should be noted that the first power line is used to transmit the first power signal ELVDD, the second power line is used to transmit the second power signal ELVSS, and the potential of the first power signal ELVDD is higher than the potential of the second power signal ELVSS. The light-emitting control line is used to transmit the luminous control signal EM. The first control line is used to transmit the first control signal, e.g. the scan signal Pscan(n). Data lines are used to transmit data signals. The third control line is used to transmit a third control signal, for example the scan signal Pscan(n−1). The first initialization line is used to transmit the first initialization signal VI2. The second initialization line is used to transmit the second initialization signal VI1.

When a channel of the compensation transistor T3 is made of low-temperature polysilicon, in order to improve the dynamic performance while reducing the gate leakage current driving transistor T1, the compensation transistor T3 can be a double-gate transistor or coupled by two transistors. Similarly, when a channel of the second initialization transistor T4 is made of low-temperature polysilicon, in order to improve the dynamic performance while reducing the gate leakage current driving transistor T1, the second initialization transistor T4 can also be a double-gate transistor or coupled by two transistors. For example, the coupling of two transistors may be realized by coupling the gates of the two transistors and coupling a source of one transistor with a drain of the other transistor. The drain of one transistor serves as the drain of the compensation transistor T3 or the second initialization transistor T4, and the source of the other transistor serves as the source of the compensation transistor T3 or the second initialization transistor T4.

It should be noted that the characteristic stability of the light-emitting device D1 is one of the key factors affecting the quality of the display. The inventor of the present disclosure found through the reliability test analysis of the display panel that when the display panel or pixel circuit operates for a long period of time, or works in a high temperature and high humidity environment for a short period of time, the characteristics of the light-emitting device D1 will change. After further research by the inventor of the present disclosure, the cause of a brightness change of the pixel circuit or the entire display panel is one of the characteristics of the light-emitting device D1 changed. The characteristics of the light-emitting device D1 is the self-capacitance C_{EL} of the light-emitting device D1.

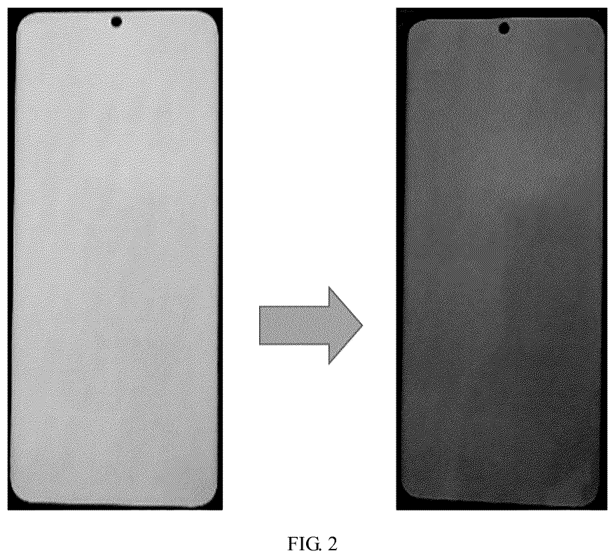

FIG. 2 illustrates a diagram of a color difference between the low grayscale white picture before and after high temperature and high humidity. The left picture in FIG. 2 is the low gray level white picture before high temperature and high humidity, and the right picture in FIG. 2 is the low gray level white picture after high temperature and high humidity. In contrast to low-grayscale white picture of the left image in FIG. 2, the right picture in FIG. 2 shows a greenish picture. After a comparison analysis by the inventor, it was found that because the display panel includes some red light-emitting devices D1, some green light-emitting devices D1, and some blue light-emitting devices D1, after long-term work or high temperature and high humidity tests, the amount of change in the capacitance C_{EL} of different color light-emitting devices D1 is also different, which leads to differences in the luminous brightness of different color light-emitting devices D1. Therefore, in contrast to low-grayscale white picture of the left image in FIG. 2, the right picture in FIG. 2 shows a greenish picture, which is a color cast.

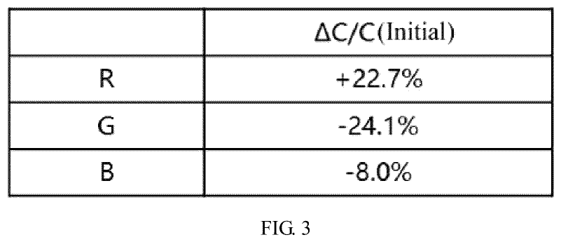

For example, as shown in FIG. 3, after 240 hours of high temperature and high humidity (temperature 60° C., humidity 90%) test of different color light-emitting device D1, the self-capacitance C_{EL} of the red light-emitting device D1 (R) increased by 22.7%, the self-capacitance C_{EL} of the green light-emitting device D1 (G) decreased by 24.1%, and the self-capacitance C_{EL} of the blue light-emitting device D1 (B) decreased by 8%. In FIG. 3, AC represents the change in the self-capacitance C_{EL} of the corresponding light-emitting device D1, and C represents the self-capacitance C_{EL} of the corresponding light-emitting device D1 before long-term work or high temperature and high humidity test, that is, the initial capacitance.

It is understandable that the light-emitting devices D1, whether it is an organic light-emitting diode, a mini-light-emitting diode, a micro-light-emitting diode or any of the quantum dot light-emitting diodes, has its own capacitance C_{EL} with different capacitances.

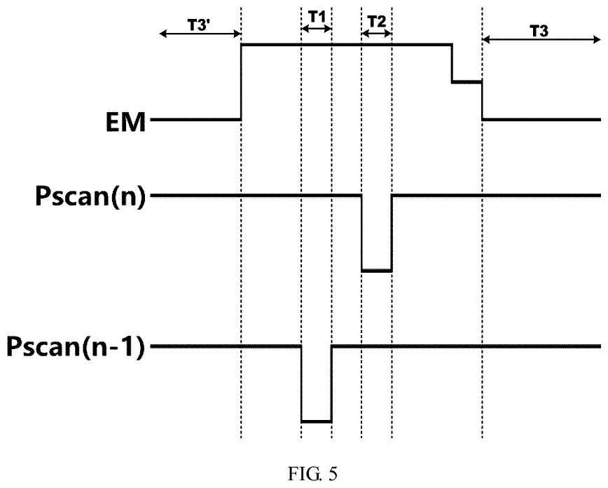

The following takes light-emitting device D1 as an example to illustrate the organic light-emitting diode. The organic light-emitting diode includes an anode, a cathode and a functional layer and/or light-emitting layer in between. In addition to the rectification characteristics of the diode, organic light-emitting diode also has a capacitive effect. FIG. 5 illustrates a timing diagram of operations of the equivalent pixel circuit shown in FIG. 1 and the capacitance of the light-emitting device D1.

In the T3′ period, the luminescence control signal EM is at low voltage level, the first light-emitting control transistor T6, the second light-emitting control transistor T5 is turned on, the first power signal ELVDD is controlled by the drive transistor T1 to drive the light-emitting device D1 to emit light. At this time the potential (V_{C}) applied on the node C is the same as the anode potential (V_{EL}) of the light-emitting device D1, that is, V_{C}=V_{EL}+V_{SS}, where V_{SS} is the cathode potential of the light-emitting device D1.

In the T1 period, the scan signal Pscan(n−1) is at low voltage level, and the second initialization signal VII resets a lower plate of the second capacitor Cst, that is, the node Q.

In the T2 period, the data signal Data is written to the lower plate of the second capacitor Cst by write transistor T2, driving transistor T1 and compensating transistor T3 in turn. At the same time, the first initialization signal VI2 resets the node (that is, the anode of the light-emitting device D1). The residual charge of the light-emitting device D1 in the previous frame is discharged to the first initialization line through the first initialization transistor T7, thereby completing the reset of the light-emitting device D1. At this point, the current I_{VI2} flowing through the first initialization transistor T7 can be roughly estimated as:

$${I}_{V 12} = 2 π * f * {C}_{EL} * ( {V}_{C} - {V}_{V 12} ) = 2 π * f * {C}_{EL} * ( {V}_{EL} + {V}_{SS} - {V}_{V 12} ) \qquad ( 1 )$$

where f is the frequency of the scan signal Pscan(n−1), V_{VI2} is the potential of the first initialization signal VI2, C_{EL} is the self-capacitor C_{EL} of light-emitting device D1, V_{C} is the potential of the node C, and V_{EL} is the anode potential of light-emitting device D1.

In the T3 period, the light-emitting control signal EM is at low voltage level, and the light-emitting device D1 begins to emit light. In this stage, the current flowing into node C through node B is I_{BC}, and the current flowing into the second power line through light-emitting device D1 (i.e., light-emitting current) is I_{VSS}, I_{BC}, I_{VSS} and I_{VI2} satisfy the following relationships:

$${I}_{BC} = {I}_{VSS} + {V}_{V 12} \qquad ( 2 )$$

Equation 2 illustrates that the current IBC controlled by the driving transistor T1, one part (I_{VSS}) is used by the light-emitting device D1 to emit light, and the other part (I_{VI2}) is consumed by the anode reset circuit of the light-emitting device D1. According to the above Equations 1 and 2, due to the change of the self-capacitance C_{EL} of the light-emitting device D1, I_{VI2} will change accordingly. In the case of unchanged I_{BC}, the I_{VSS} will change with the use of the light-emitting device D1, leading to the unstable luminous brightness of the light-emitting device D1, that is, the brightness of the light-emitting device D1 will change with its own characteristics.

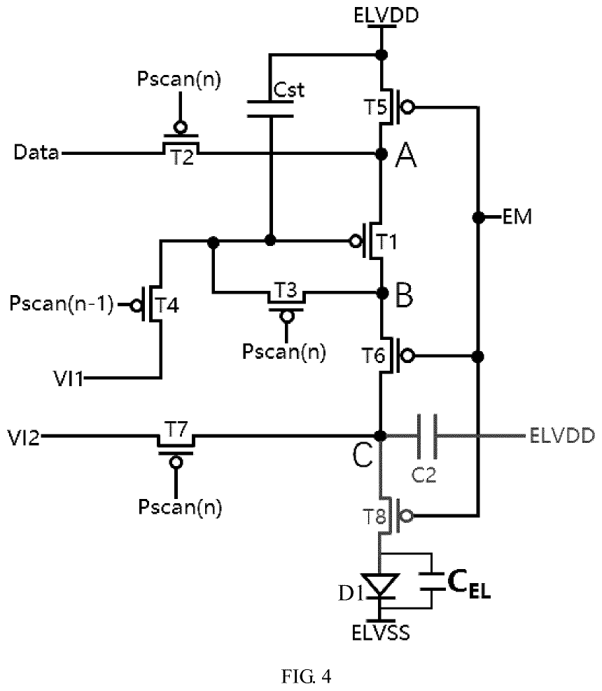

In view of the technical problem that the brightness of the light-emitting device D1 mentioned above changes with its own characteristics, the present embodiment provides a pixel circuit as illustrated in FIGS. 4 to 8. As shown in FIG. 4, the pixel circuit includes a first power line VDD, a second power line VSS, a drive transistor T1 connected in series between the first power line VDD and the second power line VSS, a first light-emitting control transistor T6 and a light-emitting device D1, a first node, a first initialization line, The second capacitor C2 and the first transistor T8, the first node is located between the first light-emitting control transistor T6 and the light-emitting device D1; the first initialization line is electrically connected to the first node through a first initialization transistor T7. The second capacitor C2 is connected between the first node and a potential transmission line. The first transistor T8 is connected between the first node and the light-emitting device D1.

It should be noted that the gate of the first light-emitting control transistor T6 is connected to the light-emitting control line, the gate of the first initialization transistor T7 is connected to the first control line, and the gate of the first transistor T8 is connected to the second control line.

In one embodiment, the pixel circuit comprises a first light-emitting control transistor T6, a first initialization transistor T7, a first transistor T8, a light-emitting device D1 and a first capacitor C2. One of the source or drain of the first light-emitting control transistor T6 is electrically connected to the first power line, the gate of the first light-emitting control transistor T6 is connected to the light-emitting control line. One of the source or drain of the first initialization transistor T7 is connected to the other of source or drain of the first light-emitting control transistor T6, one of the source or drain of the first initialization transistor T7 is connected to the first initialization line, and the gate of the first initialization transistor T7 is connected to the first control line. One of the source or drain of the first transistor T8 is connected to one of the source or drain of the first initialization transistor T7, and the gate of the first transistor T8 is connected to the second control line. The anode of the light-emitting device D1 is connected to one of the source or drain of the first transistor T8, and the cathode of the light-emitting device D1 is connected to the second power line. One terminal of the first capacitor C2 is connected to one of the source or drain of the first transistor T8, and the other terminal of the first capacitor C2 is connected to the potential transmission line.

It is understood that in the pixel circuit and display panel provided in the present disclosure, by coupling the first transistor T8 and the first capacitor C2 between the first light-emitting control transistor T6 and the light-emitting device D1, the reset current flowing through the first initialization transistor is relevant to the first capacitor C2 regardless of a self-capacitance CEL of the light-emitting device D1. Because the change in the capacitance of the first capacitor C2 with time is almost negligible, the reset current will not change with the change of self-capacitance CEL of the light-emitting device D1 to remain unchanged. The reset current is a part of the luminescent current flowing through the first light-emitting control transistor T6. Since the rest current and the luminescence current flowing through the first light-emitting control transistor T6 remain unchanged, the luminescent current flowing through the light-emitting device D1 as another part of the luminescent current flowing through the first light-emitting control transistor T6 is kept constant, thereby reducing or avoiding the influence of the change of the self-capacitance CEL of the light-emitting device D1 on its luminous brightness.

In one of these embodiments, the potential transmission line is used to transmit a constant voltage signal.

It should be noted that a capacitance the first capacitor C2 is fixed in the pixel circuit, and the constant voltage signal transmitted by the potential transmission line can ensure that the potential of node C is relatively stable. The capacitance of the first capacitor C2 can be greater than or equal to the self-capacitance CEL of the light-emitting device D1, so that anode charge of the light-emitting device D1 can be absorbed in the on-state during the light-emitting stage, or the charge in the self-capacitance CEL of the light-emitting device D1 is transferred to the first capacitor C2 during the light-emitting stage to reset the anode of the light-emitting device D1.

In one embodiment, the potential transmission line is one of the first power line, the first initialization line, or the second power line.

It should be noted that when the potential transmission line is one of the first power line, the first initialization line, or the second power line, the potential transmission line can be shared with any of the first power line, the first initialization line or the second power line, saving a dedicated potential transmission line and a space occupied by the pixel circuit, and improving the density of the pixel circuit or the aperture ratio of the display panel. Alternatively, the potential transmission line can be a separate trace, which also improves the control flexibility of the first transistor T8.

In one embodiment, the channel type of the first light-emitting control transistor T6 is the same as the channel type of the first transistor T8. The second control line is a luminescent control line.

It should be noted that in the case that the channel type of the first light-emitting control transistor T6 is the same as the channel type of the first transistor T8, the gate of the first light-emitting control transistor T6 and the gate of the first transistor T8 can share the same light-emitting control line, saving a dedicated potential transmission line and the space occupied by the pixel circuit, thereby improving the density of the pixel circuit or the aperture ratio of the display panel.

In one embodiment, the pixel circuit further comprises driving transistor T1 and a second initialization transistor T4. One of the source or drain of the transistor T1 is connected with one of the source or drain of the first light-emitting control transistor T6, the other of the source or drain of the driving transistor T1 is electrically connected to the first power line. The potential transmission line is the first power line or the second initialization line.

It should be noted that when the potential transmission line is the first power line or the second initialization line, the first power line can be multiplexed as a potential transmission line, which can also save a dedicated potential transmission line and the space occupied by the pixel circuit, improving the density of the pixel circuit or the aperture ratio of the display panel. Or, the gate of the first transistor T8 and the gate of the second initialization transistor T4 can share the same second initialization line, which can also save a dedicated potential transmission line, and is conducive to saving the space occupied by the pixel circuit, thereby improving the density of the pixel circuit or the aperture ratio of the display panel.

In one embodiment, the pixel circuit further comprises a second light-emitting control transistor T5. One of the source or drain of the second light-emitting control transistor T5 is connected to the other of source or drain of the driving transistor T1, one of the source or drain of the second light-emitting control transistor T5 is connected to the first power line, and the gate of the second light-emitting control transistor T5 is connected to the light-emitting control line or the second control line.

It should be noted that when the gate of the second light-emitting control transistor T5 is connected with the light-emitting control line, the gate of the first light-emitting control transistor T6, the gate of the second light-emitting control transistor T5 and the gate of the first transistor T8 can share the same light-emitting control line, which can save at least one of the second control line and potential transmission line, and is also conducive to saving the space occupied by the pixel circuit, thereby improving the density of the pixel circuit or the aperture ratio of the display panel.

In one embodiment, the pixel circuit further comprises a second capacitor Cst, i.e., a storage capacitor. One terminal of the second capacitor Cst is connected to the gate driving transistor T1, and the other terminal of the second capacitor Cst is connected to the first power line.

In one embodiment, the pixel circuit further comprises writing transistor T2 and compensation transistor T3. One of the source or drain of the writing transistor T2 is connected to the data line, the other of the source or drain of the writing transistor T2 is connected with the source or drain of driving transistor T1. The gate writing transistor T2 is connected to the gate of the first initialization transistor T7. One of the source or drain of the compensation transistor T3 is connected to one of the source or drain of the driving transistor T1, and the other of the source or drain of the compensation transistor T3 is connected to the gate of the driving transistor T1. The gate of the compensation transistor T3 is connected to the gate of the first initialization transistor T7.

It should be noted that the gate of the writing transistor T2, the gate of the compensation transistor T3, and the gate of the first initialized transistor T7 can share the same first control line, which is conducive to saving the space occupied by the pixel circuit, thereby improving the density of the pixel circuit or the aperture ratio of the display panel.

In one embodiment, at least one of the driving transistor T1, the first light-emitting control transistor T6, the second light-emitting control transistor T5, the first initialization transistor T7, the second initialization transistor T4, the writing transistor T2, and the compensation transistor T3 may be, but not limited to, an N-channel thin-film transistor, and may also be a metal-oxide thin-film transistor, for example, indium gallium zinc oxide thin-film transistor. Alternatively, at least one of the driving transistor T1, the first light-emitting control transistor T6, the second light-emitting control transistor T5, the first initialization transistor T7, the second initialization transistor T4, the writing transistor T2, and the compensation transistor T3 may also be a P-channel thin-film transistor, or a polycrystalline silicon thin-film transistor, for example, a low-temperature polycrystalline silicon thin-film transistor.

FIG. 5 illustrates a timing diagram of the pixel circuit shown in FIG. 4. As shown in FIG. 5 through FIG. 8, and the working process of the pixel circuit shown in FIG. 4 is explained as follows:

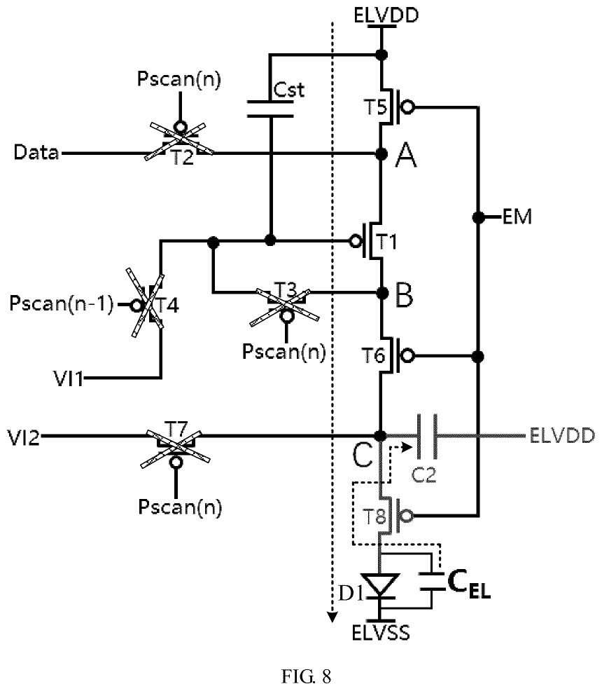

Referring to FIG. 8, in the T3′ period, the luminescence control signal EM is at low voltage level, the first light-emitting control transistor T6, the second light-emitting control transistor T5 and the first transistor T8 are turned on. The first power signal ELVDD controlled by the driving transistor T1 drives the light-emitting device D1 to emit light. At this time potential (VC) on the C node is the same as potential (VEL) on the anode of the light-emitting device D1. That is, VC=VEL+VSS, where VSS is potential on the cathode of the light-emitting device D1.

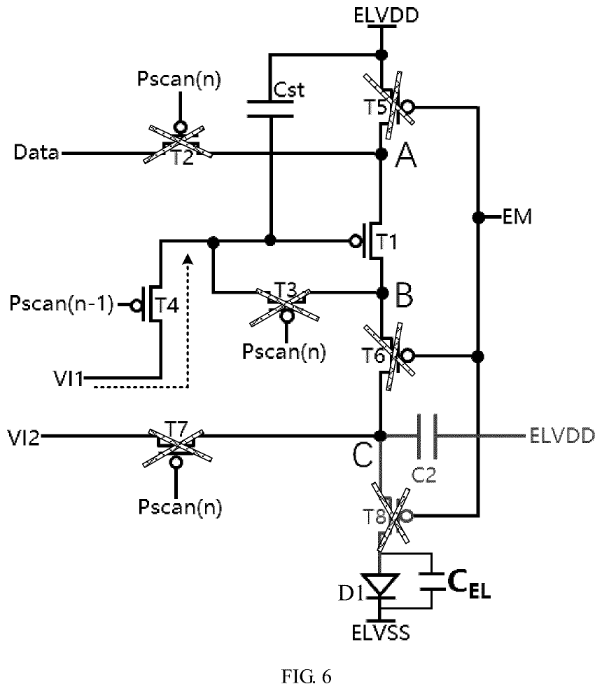

Referring to FIG. 6, in the T1 period, the scan signal Pscan(n−1) is at low voltage level, the second initialization transistor T4 is turned on, and the second initialization signal VII resets the lower plate of the second capacitor Cst.

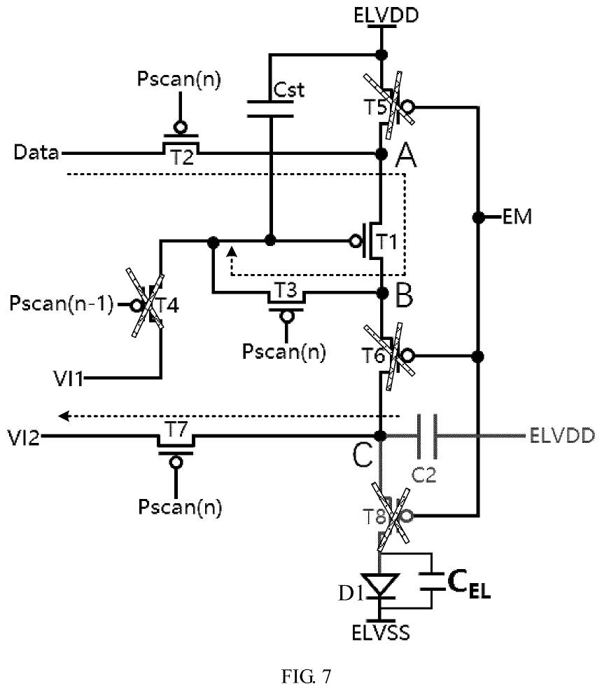

Referring to FIG. 7, in the T2 period, the scan signal Pscan(n) is at low voltage level. The writing transistor T2, the driving transistor T1, the compensation transistor T3 and the first initialization transistor T7 are turned on, and the data signal Data is transmitted to the lower plate of the second capacitor Cst through the writing transistor T2, the driving transistor T1 and the compensation transistor T3. At the same time, the first initialization signal VI2 resets the node C (i.e., a plate of the first capacitor C2, such as the lower plate). The current I_{VI2} flowing through the first initialization transistor T7 can be roughly estimated as:

$${I}_{V 12} = 2 π * f * C 2 * ( {V}_{C} - {V}_{V 12} ) = 2 π * f * C 2 * ( {V}_{EL} + {V}_{SS} - {V}_{V 12} ) , \qquad ( 3 )$$

where f is the frequency of the scan signal Pscan(n−1), V_{VI2} is the potential of the first initialization signal VI2, C2 indicates the capacitance of the first capacitor C2, VC indicates the potential on node C in FIG. 4, and V_{EL} is the potential on the anode of light-emitting device D1.

That is, in the T2 period, the first initialization transistor T7 turns on to reset the potential of the node C, at which time the first light-emitting control transistor T6 and the first transistor T8 are cut-off to avoid changing the potential of other nodes except node C.

Referring to FIG. 8, in the T3 period, the light-emitting control signal EM is at low voltage level. The first light-emitting control transistor T6, the second light-emitting control transistor T5, the driving transistor T1, and the first transistor T8 turn on, and the light-emitting device D1 begins to emit light. In this stage, the current flowing from node B to node C is IBC, and the current flowing into the second power line through light-emitting device D1 (i.e., light-emitting current) is IVSS. IBC, IVSS and IVI2 also satisfy the relationship of Equation 2: I_{BC}=I_{VSS}+I_{VI2}. The charge in the self-capacitance CEL of the light-emitting device D1 flows to the first capacitor C2 to initialize the anode potential of the light-emitting device D1.

Through the analysis of the working process of the pixel circuit shown in FIG. 4, it can be found that since the current I_{VI2} does not change with the change of the self-capacitance CEL of the light-emitting device D1, the IVSS remains stable regardless of the change of the self-capacitance CEL of the light-emitting device D1 when the IBC remains unchanged, thereby improving or avoiding the brightness change of the light-emitting device D1 in the pixel circuit due to its own characteristics.

In one of these embodiments, the conducted period of the first light-emitting control transistor T6 is the same as the conducted period of the first transistor T8.

It should be noted that the cut-off period of the first light-emitting control transistor T6 and the cut-off period of the first transistor T8 can also be the same, not only meeting the working requirements of the pixel circuit, but also reducing the control complexity of the pixel circuit.

In one embodiment, in one frame time of the pixel circuit, the start time of the first transistor T8 in the cut-off state is earlier than or equal to the beginning time when the first initialization transistor T7 turns on, and the terminal time of the first transistor T8 in the cut-off state is later than or equal to the terminal time when the first initialization transistor T7 turns on.

It should be noted that the present embodiment can ensure that the first initialization transistor T7 first resets the C node and then the charge in the self-capacitance CEL of the light-emitting device D1 transferred to the first capacitor C2 to reset the potential on the anode of the light-emitting device D1.

In one embodiment, the present embodiment provides a display panel that comprises a plurality of pixel circuits in the above embodiments.

It is understood that in the pixel circuit and display panel provided in the present disclosure, by coupling the first transistor T8 and the first capacitor C2 between the first light-emitting control transistor T6 and the light-emitting device D1, the reset current flowing through the first initialization transistor is relevant to the first capacitor C2 regardless of a self-capacitance CEL of the light-emitting device D1. Because the change in the capacitance of the first capacitor C2 with time is almost negligible, the reset current will not change with the change of self-capacitance CEL of the light-emitting device D1 to remain unchanged. The reset current is a part of the luminescent current flowing through the first light-emitting control transistor T6. Since the rest current and the luminescence current flowing through the first light-emitting control transistor T6 remain unchanged, the luminescent current flowing through the light-emitting device D1 as another part of the luminescent current flowing through the first light-emitting control transistor T6 is kept constant, thereby reducing or avoiding the influence of the change of the self-capacitance CEL of the light-emitting device D1 on its luminous brightness.

In one embodiment, in the same display panel, the capacitance of the first capacitor C2 in different pixel circuits is fixed and identical.

It should be noted that, according to the above description of FIG. 3, due to the different changes in the self-capacitance CEL of different colors of the light-emitting device D1, it will cause the display panel to show color cast on the overall display. Therefore, in the present embodiment, capacitance of the first capacitors C2 of different pixel circuits are fixed and identical, which can avoid or improve influence of the different changes in the self-capacitance CEL of different colors of the light-emitting device D1 on the brightness of the light-emitting device D1, thereby improving the color cast of the display panel after a long-term operation at high temperature and high humidity environment.

It is understood that for those of ordinary skill in the art, it may be equivalent substitution or alteration according to the technical solution of the present disclosure and its inventive idea, and all such alterations or replacements shall fall within the scope of protection of the claims appended to the present disclosure.

1. A pixel circuit, comprising:
a first power line;
a second power line;
a driving transistor, a first light-emitting control transistor and a light-emitting device connected in series between the first power line and the second power line;
a first node, between the first light-emitting control transistor and the light-emitting device;
a first initialization line, electrically connected to the first node through a first initialization transistor;
a first capacitor, connected between the first node and a potential transmission line; and
a first transistor, connected between the first node and the light-emitting device.

2. The pixel circuit according to claim 1, wherein a gate of the first light-emitting control transistor is connected with a light-emitting control line, a gate of the first initialization transistor is connected with a first control line, and a gate of the first transistor is connected with a second control line.

3. The pixel circuit according to claim 1, wherein the potential transmission line is used to transmit a constant voltage signal.

4. The pixel circuit according to claim 1, wherein the potential transmission line is one of the first power line, the first initialization line or the second power line.

5. The pixel circuit according to claim 1, wherein a channel type of the first light-emitting control transistor is the same as a channel type of the first transistor, and the second control line is a luminescent control line.

6. The pixel circuit according to claim 1, further comprising a second initialization transistor, one of a source or a drain of the second initialization transistor is connected with a gate of the driving transistor, the other of the source or the drain of the second initialization transistor is connected to the second initialization line, and a gate of the second initialization transistor is connected to the third control line;
wherein the potential transmission line is the first power line or the second initialization line.

7. The pixel circuit according to claim 6, further comprising a second light-emitting control transistor, one of the source or drain of the second light-emitting control transistor is connected to the other of the source or drain of the driving transistor, the other of the source or drain of the second light-emitting control transistor is connected to the first power line, and a gate of the second light-emitting control transistor is connected to the light-emitting control line or the second control line.

8. The pixel circuit according to claim 1, wherein in a writing stage of the pixel circuit, the first initialization line receives the first initialization signal, the first light-emitting control transistor and the first transistor are cut-off, and the first initialization signal is transmitted to the first capacitor through the first initialization transistor.

9. The pixel circuit according to claim 1, wherein in a light-emitting stage of the pixel circuit, the first light-emitting control transistor, the second light-emitting control transistor, the driving transistor, and the first transistor are turned on, and charge in a self-capacitance of the light-emitting device flows to the first capacitor through the first transistor.

10. A display panel, comprising a plurality of pixel circuits, each of the pixel circuit comprising:
a first power line;
a second power line;
a driving transistor, a first light-emitting control transistor and a light-emitting device connected in series between the first power line and the second power line;
a first node, between the first light-emitting control transistor and the light-emitting device;
a first initialization line, electrically connected to the first node through a first initialization transistor;
a first capacitor, connected between the first node and a potential transmission line; and
a first transistor, connected between the first node and the light-emitting device.

11. The display panel according to claim 10, wherein in the display panel, capacitances of the first capacitors in the plurality of pixel circuits are fixed and identical.

12. The display panel according to claim 11, wherein a gate of the first light-emitting control transistor is connected with a light-emitting control line, a gate of the first initialization transistor is connected with a first control line, and a gate of the first transistor is connected with a second control line.

13. The display panel according to claim 11, wherein the potential transmission line is used to transmit a constant voltage signal.

14. The display panel according to claim 11, wherein the potential transmission line is one of the first power line, the first initialization line or the second power line.

15. The display panel according to claim 11, wherein a channel type of the first light-emitting control transistor is the same as a channel type of the first transistor, and the second control line is a luminescent control line.

16. The display panel according to claim 11, further comprising a second initialization transistor, one of a source or a drain of the second initialization transistor is connected with a gate of the driving transistor, the other of the source or the drain of the second initialization transistor is connected to the second initialization line, and a gate of the second initialization transistor is connected to the third control line;
wherein the potential transmission line is the first power line or the second initialization line.

17. The display panel according to claim 16, further comprising a second light-emitting control transistor, one of the source or drain of the second light-emitting control transistor is connected to the other of the source or drain of the driving transistor, the other of the source or drain of the second light-emitting control transistor is connected to the first power line, and a gate of the second light-emitting control transistor is connected to the light-emitting control line or the second control line.

18. The display panel according to claim 11, wherein, wherein in a writing stage of the pixel circuit, the first initialization line receives the first initialization signal, the first light-emitting control transistor and the first transistor are cut-off, and the first initialization signal is transmitted to the first capacitor through the first initialization transistor.

19. The display panel according to claim 11, wherein in a light-emitting stage of the pixel circuit, the first light-emitting control transistor, the second light-emitting control transistor, the driving transistor, and the first transistor are turned on, and charge in a self-capacitance of the light-emitting device flows to the first capacitor through the first transistor.

20. The display panel according to claim 12, wherein a conduction time period of the first light-emitting control transistor is the same as a conduction time period of the first transistor.
